(19) United States
(12) Patent Application Publication
(10) Pub. No.: US 2008/0233336 A1
(43) Pub. Date: Sep. 25, 2008

(54) Carpet Tiles and Methods Of Making Same

(76) Inventors: Rene C. Giannopoulos, Canton, GA (US); Charles R. Patterson, Adairsville, GA (US); Tam Thi Minh Phan, Bear, DE (US)

Correspondence Address: KILYK & BOWERSOX, P.L.L.C., 400 HOLIDAY COURT, SUITE 102, WARRENTON, VA, 20186, US

(21) Appl. No.: 11/856,910

(22) Filed: Sep. 18, 2007

Related U.S. Application Data
(60) Provisional application No. 60/845,740, filed on Sep. 19, 2006.

(51) Int. Cl. D05C 17/02; B32B 37/14; B29C 47/02; B05D 1/02

(52) U.S. Cl. 428/95; 156/60; 264/257; 427/421.1

(57) ABSTRACT

Modular carpet tiles having multiple layers are described, including a laminate layer having a compatibilizing agent. The laminate layer can include at least one polyolefin functionalized with at least one unsaturated organic acid and/or at least one unsaturated organic acid anhydride, such as maleic anhydride. The functionalized polyolefin can have an acid number from about 5 to about 55 mg KOH/g. Methods of making the tiles are also described.

This application claims the benefit under 35 U.S.C. §119(e) of prior U.S. Provisional Patent Application No. 60/845,740, filed Sep. 19, 2006, which is incorporated in its entirety by reference herein.

### BACKGROUND OF THE INVENTION

The present invention relates to surface coverings and methods of making certain types of surface coverings. For instance, the present invention relates to tufted carpet tile modules having a compatibilizer agent in at least one polymer layer, such as a laminate layer.

Broadloom carpets sold in 12 ft. wide rolls constitute approximately 80% of the commercial carpet market in the U.S, with the balance (i.e., 20%) being modular tiles and 6 ft. wide roll goods. The most popular modular tile sizes in the U.S. are squares measuring 18 by 18 inches, and to a much lesser extent 24 by 24 and 36 by 36 inch-square modular sizes are also used. Modular tiles are predominantly vinyl backed.

Modular tile is gaining a greater market share in business office environments for reasons which include: ease of access to subfloor utilities; less disruption in normal work activities during carpet installation and/or replacement; simplification of modular furniture reconfiguration in open-office planning settings; ease of transport in multi-story buildings; unlimited design flexibility; ease of installation and removal; durability and cost effectiveness; selective replacement of damaged carpet capability; dimensional stability; and high performance.

The use of carpet tiles has grown rapidly during the past 25 years. Vinyl backed tiles have different properties and end-use applications compared to traditional 12 ft. wide styrene-butadiene rubber (SBR) latex backed carpets. The SBR latex chemistry is aqueous system (water based) whereas the vinyl chemistry is non-aqueous. SBR latex backed carpets are hard backed and as such, they are glued to the floor or installed over a cushioned padding. SBR latex backed carpet and vinyl backed modular tiles are essentially in two distinct categories, due to the fact that previous SBR latex backed 12 ft. wide carpet cannot be cut into carpet tiles and retain the same functionality. The construction and components of carpet tiles differ fundamentally from the construction and components of 12 ft. wide carpet. The vinyl backed tiles are engineered products that have a different cross section and use a non-woven fiberglass fleece or scrim as a stabilizing membrane. However, there is an increased demand to use more and more latex or other aqueous based chemistry due to environmental concerns. Thus, there is a need to provide carpet tiles that can be constructed to have latex layer(s) or non-latex layer(s) without the need to totally replace adjacent layers out of fear of incompatibility or de-lamination.

The present invention provides advantages and overcomes many of the disadvantages of current carpets.

### SUMMARY OF THE PRESENT INVENTION

A feature of the present invention is to provide a material, such as a surface covering, that can have a strong adhesion between dissimilar polymer compositions and/or layers.

An additional feature of the present invention is to provide a hard-backed carpet tile having a laminate layer adjoined to adjacent carpet layers such that the union between the layers retains sufficient adhesive bond strength between the dissimilar polymer compositions and/or layers.

Another feature of the present invention is to provide a simplified carpet tile which has preferably fewer layers than many conventional carpet tiles and yet provides comparable physical properties.

Still another feature of the present invention is to provide a method of making a laminate layer or a backing containing a laminate layer and incorporating the laminate layer or backing into surface coverings, such as carpet tiles.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages and in accordance with the purposes of the present invention, as embodied and broadly described herein, the present invention relates to a laminate layer that incorporates a compatibilizer that is capable of improving adhesion between dissimilar compositions and/or layers. The laminate layer can include at least one polyolefin functionalized with at least one unsaturated organic acid and/or at least one unsaturated organic acid anhydride.

The laminate layer can further include other ingredients, such as at least one amorphous poly-alpha-olefin; at least one filler; at least one tackifier resin; at least one stabilizer; and/or at least one unfunctionalized polyolefin

The term “laminate layer” as used herein refers to at least one layer that is adjacent to one or more other layers. More than one laminate layer can be used.

The present invention further relates to a surface covering, such as a carpet tile which contains the laminate layer described above as part of a multi-layered laminate structure. The carpet tile preferably has good adhesive bond strength and/or dimensional stability. Adhesive bond strength in the samples below were tested using ASTM D 3936. Relative bond strength was rated using the following criteria:
5 Will not delaminate. Sample brreaks into small pieces. Precoat side of carpet is damaged or destroyed in the delamination test.
4 Sample will delaminate after splitting the material with a knife. Olefin backing leaves more than 10% of the precoated are covered with olefin backing residue.
3 Sample will delaminate with significant resistance. Olefin backing leaves less than 10% residue on the precoat side.
2 Sample delaminates readily with little effort. Precoat carpet is undisturbed by the delimination test.
1 Sample will easily delaminate without distortion of either the backing layer or precoated carpet.

| Component | | A | D | E |
|---|---|---|---|---|
| Rextac 2315 | APAO ethylene-propylene | 25 | 20 | 20 |
| | copolymer | | | |
| Escorez 1310LC | aliphatic hydrocarbon tackifier | 5 | 10 | 10 |
| P5M6N-058 | propylene with random ethylene | 3 | 2 | 0 |
| Epolene E-43 | MAPP | 0 | 1 | 3 |
| Chemson TAOP- | antioxidant | 1 | 1 | 1 |
| 10 | | | | |
| Celceram PV-14A | coal fly ash | 66 | 66 | 66 |
| | Bond strength | 2 | 5 | 5 |

The carpet tile can have a primary backing that has textile fibers extending upwardly from a top surface of the primary backing and forming a pile surface. At least one polymeric pre-coat layer can adjoin the bottom surface of the primary backing. At least one reinforcement layer can adjoin a top surface of a secondary backing, such as a hardback layer. The laminate layer can be positioned between and adjoin a bottom surface of the pre-coat layer and a top surface of the reinforcement layer. The laminate layer may be in partial or full contact with the secondary backing due to the reinforcement layer being partially or fully covered or saturated by the secondary backing.

The present invention, in addition, relates to methods of making carpet tiles preferably having good adhesive bond strength and/or dimensional stability. The methods involve at least attaching or joining at least one laminate layer according to the present invention to one or more adjacent carpet layers to form a carpet tile.

It is to be understood that both the foregoing general description and the following detailed description are exemplary and explanatory only and are intended to provide a further explanation of the present invention, as claimed.

The accompanying drawing, which is incorporated in and constitutes a part of this application, illustrates various aspects of the present invention and together with the description, serves to explain the principles of the present invention.

### BRIEF DESCRIPTION OF THE DRAWINGS

FIG. 1 is a cross-sectional view of a carpet tile according to various embodiments of the present invention.

### DETAILED DESCRIPTION OF THE PRESENT INVENTION

The present invention relates to a laminate layer or a composition that includes a compatibilizer. The compatibilizer can permit or improve the adhesion between dissimilar compositions and/or layers. The term “compatibilizer” is referred to herein as a component of a composition or a part of a compound that promotes the compatibility of compounds or compositions. The preferred compatibilizer as discovered in this invention is a functionalized polyolefin which provides chemical interaction between a non-polar compound or compositions such as that of a polyolefin with a polar compound or compositions such as that of a polyester, a polyamide, a polyurethane, polyvinyl acetate or a polyvinyl alcohol and its derivatives. The said laminate layer containing compatibilizer also provides excellent adhesive bonding between the said laminate layer with other inorganic substrates such as a glass scrim. The improvement in adhesive bond strength between dissimilar layers via chemical interaction provides excellent adhesion thus no delamination and better mechanical properties including tear strength, tensile strength to break, and tuft bind without sacrificing other performance properties or processing capability in a hot melt and/or extrusion coating application.

The laminate layer or composition can include at least one polyolefin functionalized with at least one unsaturated organic acid and/or at least one unsaturated organic acid anhydride. This component can act or serve as a compatibilizer.

The functionalized polyolefin comprising a backbone of propylene polymer material where isotactic polypropylene is the preferred backbone. The term “crystalline” is defined herein as when a polymer has a regular order and/or pattern of molecular arrangement and a sharp melting point. The term “isotactic” is defined as when a polymer has a repetitive spatial structure. The term “atactic” is meant as not being isotactic. Therefore, a polymer that is crystalline can be isotactic, and vice versa.

The term “functionalized” is referred to herein as having at least one functional group. For example, “functionalized polymer” is meant that the polymer has at least one functional group chemically attached to the polymer backbone or chain end. In addition, the term “functionalized component” is referred to herein when a polymer is directly polymerized from monomers or other chemical agents bearing the functional group that can be attached to the polymer via a process which is known in the art as grafting using a free radical polymerization initiator Therefore, the functionalized polyolefin according to the present invention can be produced, for example, by a radical initiator and the source of the radical initiator can be peroxides, chemicals or high energy radiation. U.S. Pat. No. 4,548,993, U.S. Pat. No. 5,955,547, and U.S. Pat. No. 6,046,279 describe maleation of polypropylene by a peroxide initiator, and U.S. Pat. No. 5,411,994 describe a graft polyolefin obtained by radiation which are incorporated herein by reference. Functionalized polyolefin produced by peroxide initiated is preferred.

The functionalized polyolefin used in this invention can be made by grafting a backbone of a propylene polymer with at least one unsaturated organic acid and/or at least one unsaturated organic acid anhydride to produce an anhydride or acid content of at least 0.5 w % or higher, the preferred anhydride or acid content is in the range from 1.2 w % to 8.0 w % in the total polymer weight. The functionalized polyolefin grafted with at least one unsaturated organic acid and/or at least one unsaturated organic acid anhydride can have an acid number from 5 to 55 mg KOH/g, most preferred is from 15 to 45 mg KOH/g as measured by ASTM 1386.

Examples of unsaturated carboxylic acids used in making the functionalized polyolefin use in this patent include, but are not limited to, acrylic acid, methacrylic acid, maleic acid, fumaric acid, itaconic acid, citraconic acid, crotonic acid. The derivatives of these acids, such as their acid halides, amides, imides, anhydrides, esters and salts can also be used. Examples of unsaturated organic acid anhydrides include, but are not limited to, maleic anhydride, itaconic anhydride, and citraconic anhydride. Examples of ester derivatives are monomethyl maleate, dimethyl maleate, glycidyl maleate, dimethyl fumarate, diethyl itaconate, dimethyl citraconate, methyl acrylate, methyl methacrylate, glycidyl acrylate. Examples of salts from the carboxylic acid are: sodium acrylate, sodium methacrylate, potassium methacrylate, monosodium maleate, disodium fumarate, diammonium citraconate. Preferably, the polyolefin is functionalized with at least one unsaturated organic acid anhydride. The unsaturated organic acid anhydride is preferably maleic anhydride.

According to various embodiments, wherein the backbone of the functionalized polypropylene can be: a) a homopolymer of propylene having an isotactic index greater than 80, preferably about 85 to about 99; b) a copolymer of propylene and an olefin selected from the group consisting of ethylene and C4-C10 alpha-olefin and the copolymer having an isotactic index greater than 85; c) a terpolymer of propylene and two olefins selected from the group consisting of ethylene and C4-C8 alpha-olefins, the terpolymer having an isotactic index greater than 85; and/or d) an ethylene/propylene rubber impact modified homopolymer of propylene. The C4-C8 alpha-olefins include, for example, butene-1, pentene-1, hexene-1,4-methyl-1-pentene, and octene-1.

Isotactic Propylene homopolymer is the preferred polymer backbone in making the functionalized polypropylene used in this invention.

For instance, a functionalized isotactic polypropylene that can be used is a maleic anhydride-graft-polypropylene (PP-g-MAH). Preferably, the maleic anhydride in the functionalized polypropylene is present in an amount greater than 0.5 wt %. More preferably, the maleic anhydride is present in an amount of from about 1.2 wt % to about 8 wt %, based on the weight of the polyolefin. In general, at least one functional group can be present in an amount of at least about 1 wt %, or a range from 1 wt % to about 10 wt %, based on the weight of the polyolefin.

According to one or more embodiments, the functionalized isotactic polyolefin has an acid number from about 5 to about 55 mg KOH/g as measured by ASTM 1386. The preferred acid number can be from about 15 to about 50 mg KOH/g. A maleic anhydride-graft-polypropylene that has an acid number of about 45 mg KOH/g can be obtained from Eastman Chemical Co. under the trade name EPOLENE E43™. A maleic anhydride-graft-polypropylene that has an acid number of about 15 mg KOH/g can be obtained from Eastman Chemical Co. under the trade name EPOLENE G3015™.

According to various embodiments, where said the isotactic polypropylene backbone has an isotactic index of at least 80, most preferred from 85 to >99 as measured by classic hexane index or any modern NMR method or a softening temperature from 158 to 165° C. as measured by ASTM E-28.

Optionally, the acid or anhydride functionalized isotactic polyolefin has a melt viscosity from about 200 to about 60,000 mPas, at 190° C. The melt viscosity can be from about 400 to about 25,000 mPas, at 190° C. A maleic anhydride-graft polypropylene that has a melt viscosity of about 400 mPas, at 190° C., can be obtained from Eastman Chemical under the trade name EPOLENE E43™. A maleic anhydride-graft polypropylene that has a melt viscosity of about 25,000 mPas, at 190° C., can be obtained from Eastman Chemical under the trade name EPOLENE G 3015™. Another maleic anhydride-graft polypropylene that has a melt viscosity of about 20,000 mPas, at 190° C., can be obtained from Chemtura, formerly Crompton, under the trade name POLYBOND 3000™.

The functionalized polyolefin used as a compatibilizer in the laminate layer used in the invention can be present in an amount of from about 0.1 wt % to about 5 wt % based on the total weight of the laminate layer. Preferably, the functionalized polyolefin is present in an amount of about 0.5-3 wt %, based on the total weight of the laminate layer.

The laminate layer, which can be formed by a hot melt or extrusion coating; hot melt is the preferred method, can further include one or more of the following components: at least one amorphous poly-alpha-olefin (APAO), at least one filler, at least one tackifier resin, at least one stabilizer, and/or at least one unfunctionalized polyolefin.

The amorphous poly-alpha-olefin (APAO) can include, but is not limited to, at least one ethylene copolymer. (The amorphous poly-alpha-olefin (APAO) can include at least one polymer of propylene, such as a copolymer and/or homopolymer of propylene, and/or an olefin comprising ethylene and/or a C₄-C₁₀ alpha olefin). An amorphous poly-alpha-olefin that is an ethylene content copolymer can be obtained from Huntsman Corporation, under the trade name REXTAC 2315™. Optionally, the amorphous poly-alpha-olefin can include at least one polymer of propylene, such as a copolymer and/or homopolymer of propylene, and/or an olefin comprising ethylene and/or a C₄-C₁₀ alpha olefin. The amorphous poly-alpha-olefin can have a melt viscosity of from about 1,000 to about 9,000 mPas, at 190° C. The melt viscosity can be from about 1,500 to about 4,500 mPas, at 190° C. The amorphous poly-alpha-olefin can be present in any amount, such as from about 5 wt % to about 30 wt %, based on the total weight of the laminate layer. The amorphous poly-alpha-olefin can be present in an amount of about 15 wt %, based on the total weight of the laminate layer.

The filler can be any conventional filler, especially those types traditionally used in carpets. Examples include, but is not limited to, coal fly ash, calcium carbonate, barium sulfate, carbon black, metal oxides, inorganic material, natural material, alumina trihydrate, magnesium hydroxide, bauxite, talc, post consumer glass, or post industrial glass, or any combination thereof. Preferably, the filler is coal fly ash. More preferably, the filler is a blend of coal fly ash and post consumer glass. The filler can have any particle size, typically ranging from 0.5 to 200 microns A flame retardant(s) can be present. Coal fly ash can be obtained from Boral Industries, under the trade name Celceram PV-14A™. The filler can be present in an amount of from about 40 wt % to about 80 wt %, based on the weight of the laminate layer. More preferably, the filler is present in an amount of about from 65 to 70 wt %, based on the weight of the laminate layer. Other amounts below and above these ranges can be used.

The tackifier resin can be, but is not limited to, an aliphatic hydrocarbon, a fatty acid, a cycloaliphatic hydrocarbon, an aromatically modified aliphatic hydrocarbon, or any combination thereof. Preferably, the tackifier resin is an aliphatic hydrocarbon. An aliphatic hydrocarbon tackifier resin can be obtained from ExxonMobil Chemical, under the trade name ESCOREZ 1310LC™. The tackifier resin can be present in any amount such as from about 5 wt % to about 20 wt %, based on the weight of the laminate layer. More preferably, the tackifier resin is present in an amount of about 10-15 wt %, based on the weight of the laminate layer. Other amounts below and above these ranges can be used.

The stabilizer can be at least one antioxidant and/or other stabilizing material. Any antioxidant commercially available or known can be used. An exemplary antioxidant is a high molecular weight hindered phenol, that has a TAOP-10 (total antioxidant potential of 10). The stabilizer can be present in an amount of from about 0.1 wt % to about 5 wt %, based on the total weight of the laminate layer. More preferably, the stabilizer is present in an amount of about 0.1 to 1 wt %, based on the total weight of the laminate layer. Other amounts below and above these ranges can be used.

As described above, an additional component that can be added to the laminate layer includes at least one unfunctionalized polyolefin, wherein the unfunctionalized polyolefin can be: a) a homopolymer of propylene having an isotactic index greater than 80, preferably about 85 to about 99; b) a copolymer of propylene and an olefin selected from the group consisting of ethylene and C4 to C10 alpha-olefin and the copolymer having an isotactic index greater than 85; c) a terpolymer of propylene and two olefins selected from the group consisting of ethylene and C4 to C8 alpha-olefins, the terpolymer having an isotactic index greater than 85; d) an ethylene/propylene rubber impact modified homopolymer of propylene. The C4 to C8 alpha-olefins include, for example, butene-1, pentene-1, hexene-1,4-methyl-1-pentene, and octene-1.

Isotactic propylene homopolymer and ethylene/propylene copolymer are the preferred unfunctionalized polyolefin used in this invention.

An example of an unfunctionalized polyolefin is a random ethylene-propylene copolymer, available from Huntsman Corporation, under the trade name P5M6N-058 or a copolymer available from Basell Polyolefin under the trade names: Softell CA10™ Or Adflex KS021P™ or Aflex Q100™. Optionally, the unfunctionalized propylene can have a melt flow rate from <0.10 to 80 g/10 min., most preferred is from 10 to 65 g/10 min. as measured by ASTM D1238 at 230° C. and 2.16 Kg. A ultra high MFR, like ultrahigh MFR PP of greater than 1000 MFR can be used.

This additional component can be present in an amount of from about 0.5 wt % to about 5 wt % or more, based on the total weight of the laminate layer. This additional component can be present in an amount of about 1 to 3 wt %, based on the total weight of the laminate layer.

Additional components may be present in the laminate layer as desired. The various components of the laminate layer can be blended together and formed into one or more laminate layers. The laminate layer can be incorporated into any surface covering. The surface covering can be, but is not limited to, a broadloom carpet, a modular carpet tile, or a wide roll carpet (e.g. 6 ft. wide). Preferably, the surface covering is a carpet tile or 6 ft. roll goods. The amount of the laminate layer present in the surface covering can be any amount as desired, and can be based on the type of surface covering. For instance, if the surface covering is a carpet tile, the laminate layer is preferably present in an amount of from about 25 ounces to about 35 ounces per square yard of the carpet tile. Other amounts can be used.

According to various embodiments, the carpet tile can have additional layers attached to the laminate layer, wherein the laminate layer has a top surface and a bottom surface. For instance, the carpet tile can include a primary backing having a top surface and a bottom surface. Fibers can be tufted into, woven into, or bonded to, and extended upwardly from the top surface of the primary backing. A pre-coat layer having a top surface and a bottom surface can be present and the top surface of the pre-coat can be affixed to the bottom surface of the primary backing and the bottom surface of the pre-coat layer can be affixed to the top surface of the laminate layer. At least one reinforcement layer having a top surface and a bottom surface can be present, and the top surface of the reinforcement layer can be affixed to the bottom surface of the laminate layer. A hardback layer can be present having a top surface and a bottom surface, wherein the top surface of the hardback layer can be affixed to the bottom surface of the reinforcement layer.

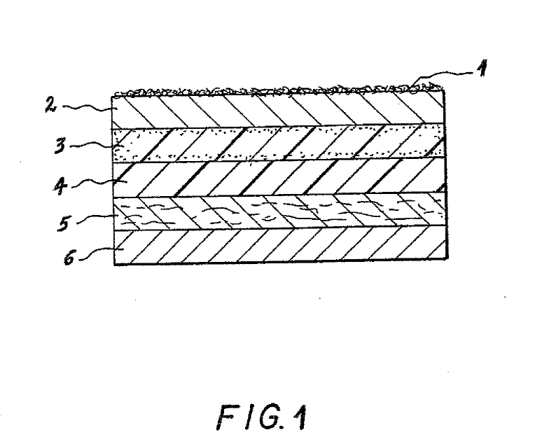

As shown in FIG. 1, an exploded cross-sectional view of a preferred surface covering is depicted. The FIGURE is not to scale and is provided to simply show a cross-sectional fragmentary view of various embodiments of the present invention. As can be seen, fibers 1 can be tufted into a tufting substrate or primary backing 2. An adhesive pre-coat layer 3 can be affixed to the primary backing 2 in order to secure the fibers 1 in the primary backing 2. A laminate layer 4 can be located beneath the pre-coat layer 3. Located beneath the laminate layer 4 can be a stabilizer or reinforcement layer 5. Located below the reinforcement layer 5 can be a secondary backing layer or a hardback layer 6. Certainly, for purposes of the present invention, additional layers not shown in FIG. 1 can be used, such as, one or more reinforcement layers, pre-coat layers, additional intermediate or laminate layers, and/or additional backing layers which can be the same or different. In each case, each layer can be affixed in some manner such as by casting, adhesive, or other means conventional in the art.

The fibers can be synthetic or natural. Any commercially available yarn or fiber can be used. The fibers can be nylon 6,6, nylon 6, polyester, polypropylene, acrylic, poly(lactic acid), wool, or any combination thereof. Optionally, the fibers are anti-soil and/or anti-stain treated. The fibers can be attached to the primary backing in any manner known in the art, such as, but not limited to, tufted into, woven into, or bonded to, and extended upwardly from the top surface of the primary backing. The fibers can be in any form when attached to the primary backing, such as, but not limited to, a fiber, web, yarn, thread, sliver, woven fabric, knitted fabric, non-woven fabric, upholstery fabric, tufted carpet, pile carpet, or any combinations thereof. The fibers can be natural and/or synthetic materials. Preferably, the fibers are face yarn tufted into the primary backing. Preferably, the fibers are present in an amount of from about 10 ounces to about 40 ounces, per square yard of the carpet. Other amounts can be used.

The primary backing can be made of any material known in the art. For instance, the primary backing can be made of, but is not limited to, a styrene polymer such as, a styrene-butadiene-styrene polymer (SBS) or a similar polymer, polypropylene, polyester, nylon, other thermoplastic polymers, or any combination thereof. For example, if the primary backing is a thermoplastic material, an aliphatic thermoplastic resin such as one derived by polymerization or copolymerization of an ethylenically unsaturated monomer, can be used. The monomer can be an ethylenically unsaturated hydrocarbon such as an olefin or a nitrite (such as an acrylonitrile), vinyl or vinylidene chloride, vinyl acetate, or an acrylate, such as ethylacrylate or methyl methacrylate. Other thermoplastic materials include, but are not limited to, polyethylene, ethylene/vinyl acetate, polyvinyl chloride, polyisobutylene, or any combination thereof. Preferably, the thermoplastic material is a vinyl-type material such as a vinyl resin and more particularly a polyvinyl chloride-type material.

Thermoplastic materials are not subject to chemical change when heated and are not infusible, consequently they will gel or soften when a solvent is applied. Suitable polymers for the backing layers of the present invention can be derived from at least one monomer such as, but is not limited to, acrylic, vinyl, chlorinated vinyl, styrene, butadiene, ethylene, butene, and copolymers or blends thereof.

Preferably, the primary backing are made of fibers, such as, but are not limited to, polyester fibers, nylon fibers, polypropylene fibers, or any combination thereof. The fibers of the primary backing can be assembled in any manner known in the art. Preferably, the fibers of the primary backing are assembled in, but are not limited to, a woven fabric, non-woven fabric, laminated film, or any combination thereof. The primary backing can be present in any amount desired. Preferably, the primary backing is present in an amount of from about 2 ounces to about 5 ounces, per square yard of the carpet. Other amounts can be used.

According to the present invention, the polymeric pre-coat layer can serve to hold in place the fibers that have been tufted into the primary backing. Any conventional pre-coat material can be used. The polymeric pre-coat layer can be disposed below and affixed to, the bottom surface of the primary backing. The pre-coat layer can be aqueous or non-aqueous based. The pre-coat layer can be a vinyl acetate ethylene latex or other suitable materials such as, but not limited to, polyvinyl chloride, styrene-butadiene-rubber latex, acrylic, hot melt adhesive, or any combination thereof. The coating composition can be a polymer or copolymer of a vinyl compound, e.g., polyvinyl chloride, polyvinylidine chloride, polyethylene chloride, polyvinyl acetate, polyvinyl acetal, and the like, and copolymers and mixtures thereof. A specific example of a resin coating composition is a vinyl chloride, resin-based plastisol, wherein the plasticizer component of the plastisol is a phthalate-based compound, such as an alkyl phthalate substituted one or two times with a linear or branched C₅-C₁₂ alkyl group, which is included in an amount by weight equal to between about 15 to 60 percent of the weight of the vinyl chloride resin component. Particular vinyl chlorides include Vinycel 123 (Policyd SA DE CV, Mexico), Geon 138 (Polyone, Inc. Cleveland, Ohio). Particular alkyl phthalate plasticizers include Jayflex DINP and Jayflex DIHP (ExxonMobil Chemical America, Houston, Tex.). The pre-coat layer can further include, but is not limited to, a filler, an oil extender, a stabilizer, a thermoplastic resin, a thermoset resin, or any combination thereof.

Preferably, the pre-coat layer includes a latex polymer compounded optionally with at least one filler, at least one flame retardant, and/or at least one additive, or any combination thereof. The latex polymer can include, but is not limited to, a vinyl acetate-ethylene (VAE) latex, an acrylic latex, a styrene-butadiene-rubber (SBR) latex, or any blend thereof. The latex is preferably a VAE latex. Preferably, the pre-coat layer is present in an amount of from about 18 ounces to about 25 ounces, per square yard of the carpet. Other amounts can be used.

The reinforcement layer or stabilizer layer can include any reinforcement-type material. For purposes of the present invention, the reinforcement-type material can be a particulate material or a fibrous material. In more detail, the reinforcement-type material is a material that can provide or contribute to the dimensional stability of the carpet tile. For instance, the reinforcement layer can include fibers or particulates such as, but is not limited to, carbon fibers, inorganic oxide fibers, natural fibers, fiberglass, glass beads, carbon black, hollow, solid glass, or ceramic beads, other carbonaceous-type reinforcing materials, polymeric fibers, oxide particles or beads, and the like, or any combination thereof. Preferably, the reinforcement layer includes fiberglass. The fiberglass can be in any form such as, but is not limited to, woven, non-woven, in a wet laid mat, in a scrim, or any combination thereof. Preferably, the reinforcement layer is a non-woven fiberglass and/or is a fiberglass fleece or sheet that is preferably from about 0.8 to about 2 lbs/100 ft², e.g., 1.4 lbs/100 ft², such as Johns Manville 8500™ Series Fiberglass Mat which is available from Johns Manville Corporation. The reinforcement layer can comprise recycled material. The reinforcement layer can be present in any amount desired, with respect to the carpet tile. Preferably, the reinforcement layer is present in an amount of about 2 ounces per square yard of the carpet. Other amounts can be used. The reinforcement layer can sink, partially or fully, into a layer above or below it. For instance, the reinforcement layer can be partially or fully covered by the secondary backing layer prior to hardening. Thus, the laminate layer in at least one embodiment is in contact with the secondary backing layer.

Located beneath the reinforcement layer can be a final layer, which for purposes of the present invention, can be considered the hardback layer. Typically secondary backings are attached fibrous materials such as a woven or nonwoven scrim. This secondary backing layer can provide many functions to the carpet tile. For instance, the hardback layer can further strengthen the overall carpet or carpet tile. The hardback layer can, alternatively or in addition, provide dimensional stability. The hardback layer, as an option, can serve as a layer to further secure the reinforcement layer that is used. The hardback layer can be made of the same polymeric materials as the pre-coat layer or it can be made from different polymeric materials. Examples of the polymers that can form the secondary backing layer are described above with respect to the polymeric pre-coat layer, or below with respect to the preferred embodiments.

With regards to the hardback material, for purposes of the present invention, the hardback layer can be a thermoplastic or thermoset material. The thermoplastic material can be an aliphatic thermoplastic resin such as one derived by polymerization or copolymerization of an ethylenically unsaturated monomer. The monomer can be an ethylenically unsaturated hydrocarbon such as an olefin or a nitrile (such as an acrylonitrile), vinyl or vinylidene chloride, vinyl acetate, or an acrylate, such as ethylacrylate or methylmethacrylate. More particularly, the thermoplastic material can be a polyethylene, ethylene/vinyl acetate, polyvinyl chloride, polyisobutylene, and the like. Preferably, the thermoplastic material is a vinyl-type material such as a vinyl resin and more particularly a polyvinyl chloride-type material. Also, at least one plasticizer can also be present.

Other suitable polymers for the hardback layer, as well as the primary backing layer, of the present invention can be derived from at least one monomer of acrylic, vinyl, chlorinated vinyl, styrene, butadiene, ethylene, butene, or copolymers or blends thereof. An exemplary composition for the primary backing and/or the hardback layer is a polymer or copolymer of a vinyl compound, or halogenated polyolefin, e.g., polyvinyl chloride, polyvinylidine chloride, polyethylene chloride, polyvinyl acetate, polyvinyl acetyl, chlorinated polyethylenes, and the like, and copolymers and mixtures thereof.

In one or more embodiments, the hardback layer can be made from at least a styrene polymer such as a styrene-butadiene-styrene polymer or related types of polymers.

The hardback can be a cushion backing or a hardback backing. In more detail, the hardback can be a solid thermoplastic backing or a foamed thermoplastic backing. For example, the thermoplastic foamed backing can be a foamed olefin or vinyl backing, such as a closed-cell olefin or vinyl foamed backing. Generally, the hardbacks can contain at least one plasticizer, in conventional amounts, like about 50 phr to about 80 phr and can include other ingredients, like wetting agents conventionally used in hardbacks.

Chemically or mechanically expanded thermoplastic foamed backings can be used as the hardback. Alternatively, a pre-blown foamed hardback can be laminated, such as by heat, to another layer, such as, the primary backing. The solid thermoplastic hardback can be similarly prepared by casting or by lamination.

Conventional blowing agents can be used and include, but are not limited to, azodicarbonamide, p,p-oxybis(benzenesulfonylhydrazide), p-toluenesulfonylhydrazide, and the like, such as the ones described in U.S. Pat. No. 3,661,691, which is incorporated in its entirety by reference herein.

According to various embodiments, the secondary backing layer is preferably a non-woven or woven material, such as polypropylene. Other materials can be used to form the secondary backing such as polyester and the like. Typically, the secondary backing layer can be an Action Back® secondary backing as known in the industry. The secondary backing layer can comprise a fused recycled material, such as described in U.S. Pat. No. 6,316,075 B1, incorporated in its entirety by reference herein. The secondary backing can be formed by extruding, casting, or by lamination.

According to various embodiments, the hardback layer and the pre-coat layer can have the same or similar composition or one or more components therein. The hardback layer and/or the pre-coat layer may have the same composition as the hot melt laminate layer which includes a compatibilizer agent as previously described or may have the sample composition as the hot melt laminate layer, without the coupling agent. In other words, the composition for these layers does not contain a compatibilizer agent such as an acid or anhydride functionalized polyolefin. For example, the pre-coat layer and/or the hardback layer can include at least one amorphous poly-alpha-olefin, at least one filler, at least one tackifier resin, at least one stabilizer, and/or at least one unfunctionalized polyolefin.

According to one or more embodiments, similar to the laminate layer, the pre-coat layer and/or the hardback layer can have at least one amorphous poly-alpha-olefin (APAO) that has a melt viscosity from about 1,000 to about 9,000 mPas, at 190° C., and at least one copolymer and/or homopolymer of propylene, and an olefin including ethylene and/or C₄-C₁₀ alpha olefin. The filler preferably includes coal fly ash, calcium carbonate, barium sulfate, alumina trihydrate, magnesium hydroxide, bauxite, talc, post consumer glass, post industrial glass, or any combination thereof. The tackifier resin preferably includes an aliphatic hydrocarbon, a cycloaliphatic hydrocarbon, an aromatically modified aliphatic hydrocarbon, fatty acid or any combination thereof. The stabilizer preferably is a high molecular weight hindered phenol. Optionally, the unfunctionalized propylene can have a melt flow rate from <0.10 to 80 g/10 min., most preferred is from 10 to 65 g/10 min. as measured by ASTM D1238 at 230° C. and 2.16 Kg.

According to one or more embodiments, the hardback layer and/or the pre-coat layer can have another difference as compared to the laminate layer. Instead of the ethylene copolymer or homopolymer for the amorphous poly-alpha-olefin, the laminate layer can have a combination of homopolymers, copolymers or terpolymers with varying levels of comonomer. A preferred amount of the components present in the hardback layer and/or the pre-coat layers, based on the weight of the hardback layer or the pre-coat layer are: from about 5 to about 30 wt % of the APAO, from about 40 to about 80 wt % of the filler, from about 5 to about 15 wt % of the tackifier resin, from about 0.1 to about 5 wt % of the stabilizer, and from about 0.1 to about 5 wt % of the ethylene-propylene copolymer. More preferably, the amount of the components present in the hardback layer and/or the pre-coat layers, based on the weight of the hardback layer or the pre-coat layer are: about 20 wt % of the APAO about 66 wt % of the filler, about 10 wt % of the tackifier resin, about 1 wt % of the stabilizer, and about 3 wt % of the unfunctionalized polyolefin.

Therefore, according to various embodiments, a layer similar to the laminate layer, but without the functionalized polyolefin, can serve as, or eliminate, the pre-coat layer and/or can serve as the hardback layer, as previously described. Alternatively, these layers can all incorporate the functionalized polyolefin as previously described, in order to use the compatibilizer for increased bond strength and/or dimensional stability between the different compositions and layers. For example, the hot melt laminate layer can be substituted for the previously described latex pre-coat layer. This substitution has a particular application for broadloom carpets where the non-aqueous properties of the hot melt laminate layer can provide additional benefits. The use of compatibilizer or coupling agents in one or more formulas or layers can provide enhanced bonding of the layers or coatings to different components or compositions of the carpet tile, such as the fiberglass, the face yarns, the primary backing and/or the secondary backing.

Any amount of the hardback layer can be present, with respect to the carpet tile. Preferably, the hardback layer is present in an amount of from about 30 ounces to about 40 ounces, per square yard of the carpet tile.

For purposes of the present invention, any embodiment can contain more than one type of layer, e.g., more than one pre-coat layer, more than one laminate layer, and so on. Any combination is possible. In addition, blowing agents, catalyst, fillers, surface-active additives, flame retardants, anti-microbial agents, and other conventional ingredients can also be present in any of the layers.

For example, one or more layers of fiberglass can be used. Some carpet products are more difficult to stabilize than others, due to construction differences in the greige. An additional layer of the reinforcement material can be incorporated into the product. This can normally be inserted at the point of the pre-coat application. The reinforcement layer can include a non-woven, woven or wet laid fiberglass mat or scrim as previously described.

Another example of incorporating additional components to the carpet tile can be in the woven or non-woven secondary backing layers. For instance, if a different backing appearance or texture is desired, a high melt woven or non-woven scrim can be applied directly to the hardback layer while the hardback layer is still at an elevated temperature. Optionally, compatibilizers or coupling agents can be incorporated into the any of the layers, such as the primary or the secondary backing layers, and can improve the bonding to the two materials.

Any of the materials for the layers of the carpet tile can be obtained from recycled materials or carpets. For instance, fillers that incorporate post-industrial or post-consumer recycled content, such as fillers recovered from carpet recycling processes and/or ground glass from other recycling operations, can be substituted in part or in whole for the previously described fillers. Optionally, recycled polymers can also be used. Polymers recovered from industrial or post-consumer waste streams can be used to replace all or a portion of the previously described polymers. Examples of recycled polymers, include, but are not limited to, recycled or reclaimed polyolefin, polyethylene and related polymers. Alternatively, recycled or reclaimed carpet as can be used as feedstock. Carpets manufactured in part with olefin polymers recovered from industrial or post-consumer carpet waste streams can be used to replace all or a portion of the previously described polymers. The carpets would have to be reprocessed through grinding and re-melting processes prior to application in the process. Recycled materials and techniques of using them can be accomplished using the techniques and materials described in, for example, U.S. Pat. Nos. 6,936,201 and 6,316,075, which are incorporated by reference herein in their entireties. Preferably, the entire carpet tile or nearly the entire carpet tile is made from recycled materials.

Various coatings or layers are discussed previously and below, and unless stated otherwise, are preferably of a substantially uniform thickness and can be applied using techniques known to those skilled in the art. The preparation of the composition for each layer can be by any technique known in the art. For example, the preparation of the composition for the hot melt laminate layer can be accomplished with a variety of mixing techniques. Preferably, the compositions of the laminate layer, or any layer, are produced by compounding in a hot-melt mixer, using a batch process. The compositions can then be stored at an elevated temperature until needed. The compound can also be cooled and pelletized until needed. The pellets can be reheated prior to application or stored in a molten state until needed. Alternatively, the compositions can be produced in a continuous mixing process and/or using a compounding extruder. The compositions produced by this process can be applied directly to the coating line. They can also be cooled and pelletized until needed. The pellets can be reheated prior to application or stored in a molten state until needed.

The sequence of forming any of the various layers is not critical to the present invention. Production of the carpet tiles may include intermediate steps of forming one or more carpet strata by joining two or more constituent layers together. Furthermore, one or more of the layers may be formed “upside down” relative to the orientation of the finished product as a floor covering. Thus, directional references are merely given for the purpose of aiding the reader and are not intended in any way to limit the scope of the present invention.

In each case, the individual layers described above, are affixed in some manner such as by casting, extruding, and/or laminating the various layers on a previously formed layer, or by other means conventional in the art. As an alternative to using the primary backing as the substrate on which all other layers are applied, it is certainly within the bounds of the present invention to form any layer of the surface covering first and then add other desirable layers to the top and/or bottom surface of the first layer formed. For example, the hardback layer can be formed first and all of the other layers applied thereon or alternately all layers could be applied on the secondary backing.

For example, the laminate layer can be applied to the bottom surface of the pre-coat directly or by indirect belt coating. Any method of applying the laminate layer can be used. For example, the layer can be applied by, but is not limited to, using a hot roll coater, extruder, a hot knife coater, a slot coater, a spray applicator, or any combination thereof. Each layer can be applied by using heat and/or pressure, belts, rolls, or any method or machine known in the art, described in, for example, U.S. Pat. No. 6,936,201 and U.S. Pat. No. 6,316,075, which are incorporated herein by reference in their entireties.

According to various embodiments, the laminate layer can be applied by indirect belt coating, wherein the laminate layer is applied onto a process line belt and is independent of applying the pre-coat. For example, the hardback layer can be applied onto a process line belt. The reinforcement layer is then applied onto the hardback layer. The laminate layer is then applied onto the reinforcement material layer to form a bottom part of the carpet tile. The bottom part is then attached to the bottom surface of the pre-coat layer of a pre-coated carpet tile to form a finished carpet tile. Alternatively, the laminated layer can be applied “upside down” relative to the orientation of the finished product as a floor covering. The laminate layer can be applied on the bottom surface of the pre-coat layer of a pre-coated carpet tile. The reinforcement layer is then applied onto the laminate layer. The hardback layer is then applied onto the reinforcement material layer.

The carpet formed by the embodiments of the present invention can be cut to form a modular carpet tile of any desired size and shape. Preferably, the tile is square. The preferred square carpet tile can be any conventional size, and is preferably, 24″×24″ or 36″×36″, or more preferably, 18″×18″. Other possible sizes include 50 cm×50 cm and 60 cm×60 cm, and sizes above and below. As stated earlier, the carpet tile of the present invention preferably has exceptional dimensional stability. The modular carpet tile of the present invention preferably meets or exceeds all requirements for commercial carpet tiles.

Another way to view the combining of the layers referenced above, by using a compatibilizer, or a laminate layer containing a compatibilizer is that each layer cannot be delaminated from the other layers of the carpet tile without damage to the layers. Alternatively, a stronger bond is created between the different compositions or layers in order to provide better dimensional stability of the carpet tile. In other words, the compatibilizer or laminate layer containing the compatibilizer, can improve the adhesion between dissimilar polymer compositions and/or acts as a coupling agent between inorganic components and a polymer matrix. Additionally, the compatibilizer can improve the viscosity and/or rheology, i.e., the flow and coatability, of the compositions of any of the layers in the melt phase. Furthermore, by using the compatibilizer or laminate layer containing the compatibilizer, preferably less coating material, adhesives or no adhesives are needed to adjoin one layer to another. Therefore, the present invention allows lowering of cost of production and more efficient material usage, while improving the environmental impact. The laminate and/or hardback layers can be a polyethylene compound or comprise a polyethylene compound, such as the formula below (other amounts and substitutes for one or more of the ingredients can be made):

| Polyethylene | | | |
|---|---|---|---|
| Formula | wt % | supplier | description |
| Polyethylene | 25-35 | Dow | LLDPE or LDPE Polyethylene |
| Polymer | | | polymer, including homo- |
| | | | polymers and copolymers. |
| Styrene Block | 0-5 | Kraton | Styrene-Butadiene-Styrene |
| Copolymer | | | bock polymer |
| Functionalized | 0-5 | Crompton | Maleated polypropylene or |
| polymer | | | polyethylene polymer |
| Tackifier Resin | 5-15 | Exxon | Hydrocarbon Tackifier |
| Coal Fly Ash | 50-60 | Boral | Filler |
| Antioxidant | 0.1-1 | Chemson | |

The present invention will be further clarified by the following examples, which are intended to be purely exemplary of the present invention.

### EXAMPLES

### Example 1

### A Pre-Coat was Prepared with the Following Formula

| % Solids | Ingredient | Dry | Wet |
|---|---|---|---|
| | Water | | 19.21 |
| 40.0 | Stansperse 440 | 0.50 | 1.25 |
| 63.0 | Airflex CA-54 | 100.00 | 158.73 |
| 100.0 | Whiting | 200.00 | 200.00 |
| 33.0 | Stanfax 509 | 1.00 | 3.03 |
| 70.0 | Stanfax 519 | 0.50 | 0.71 |
| 46.0 | TX-135 Starch | 6.00 | 13.04 |
| 15.0 | Paragum 277 | 0.75 | 5.00 |

These ingredients were blended together to form a uniform mixture. AIRFLEX CA-54 is a vinyl acetate-ethylene (VAE) emulsion, available from Airproducts and Chemical, Inc. STANFAX 509 and STANFAX 519 are surfactant blends available from Para-Chem. They are specially formulated to meet the diverse coating needs of a broad range of latex applications and are effective with SBR, EVA (VAE), acrylic, SBR-carboxylated, and many other aqueous latex dispersions. Paragum 277 is a sodium polyacrylate-based thickener used to control the viscosity of the coating. Starch is used to inhibit blistering in the precoat layer.

The pre-coat composition was applied directly to the back of a greige carpet using a knife coater in an amount of 18-25 ounces per sq. yard of carpet.

### Example 2

### A Hardback Layer was Prepared with the Following Formula

| | wt % based |
|---|---|
| Ingredient | on layer |
| Rextac 2215: AP AO - low ethylene content copolymer | 15 |
| Rextac 3445: APAO - high ethylene content copolymer | 5 |
| PV-14A: filler - coal fly ash | 66 |
| Escorez 1310LC: aliphatic hydrocarbon tackifier resin | 10 |
| TAOP-10: antioxidant stabilizer | 1 |
| P5M6N-058: unfunctionalized isotactic polypropylene with | 3 |
| random ethylene copolymer | |

These ingredients were blended together to form a uniform mixture. Heat was applied. REXTAC 2215, REXTAC 3445 and P5M6N-058 are available from Huntsman Corporation. Celceram PV14-A is available from Boral Industries ESCOREZ 1310LC is available from ExxonMobil Chemical. The preferred antioxidant has a total antioxidant potential of 10 (TAOP).

The composition of the hardback layer was applied onto a process line belt as a hot melt and was independent of forming and/or applying the pre-coat layer.

### Example 3

### A Laminate Layer was Prepared with the Following Formula

| | wt % based |
|---|---|
| Ingredient | on layer |
| Rextac 2315: APAO - medium ethylene content copolymer | 15 |
| Epolene E-43: functionalized isotactic PP - | 1 |
| (PP-g-MAH) ~7-8% maleic anhydride | |
| PV-14A: filler - coal fly ash | 66 |
| Escorez 1310LC: aliphatic hydrocarbon tackifier resin | 10 |
| TAOP-10: antioxidant stabilizer | 1 |
| P5M6N-058: unfunctionalized isotactic polypropylene | 2 |
| with random ethylene copolymer | |

These ingredients were blended together to form a uniform mixture. Heat was applied. REXTAC 2315 and P5M6N-058 are available from Huntsman Corporation. EPOLINE E-43 is available from Eastman Chemical. Celceram PV14-A is available from Boral Industries. ESCOREZ 1310LC is available from ExxonMobil Chemical. The preferred antioxidant has a total antioxidant potential of 10 (TAOP-10).

The composition of the laminate layer was applied as a hot melt onto a pre-formed layer. The pre-formed layer was a reinforcement layer which included fiberglass, on top of a hardback layer.

### Example 4

### A Hot Melt Pre-Coat Layer was Prepared with the Following Formula

| | wt % based |
|---|---|
| Ingredient | on layer |
| Rextac 2215: APO - low ethylene content copolymer | 28.5 |
| GFP-101: filler - calcium/magnesium carbonate | 54.0 |
| Escorez 1310LC: aliphatic hydrocarbon tackifier resin | 15.0 |
| TAOP-10: antioxidant stabilizer | 1.0 |
| P5M6N-058: unfunctionalized isotactic polypropylene | 1.5 |
| with random ethylene copolymer | |

These ingredients were blended together to form a uniform mixture. Heat was applied. REXTAC 2215 and P5M6N-058 are available from Huntsman Corporation. GFP-101 is available from Oglebay Norton Filler Products ESCOREZ 1310LC is available from ExxonMobil Chemical. The preferred antioxidant has a total antioxidant potential of 10 (TAOP-10).

This hot melt pre-coat layer was substituted for the pre-coat layer from Example 1. This nonaqueous precoat provides a moisture barrier, improved wickback stain resistance, and better wet tuft bind.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A carpet tile having at least one laminate layer comprising at least one polyolefin functionalized with at least one unsaturated organic acid and/or at least one unsaturated organic acid anhydride, wherein said polyolefin has an acid number from about 5 to about 55 mg KOH/g.

2. The carpet tile of claim 1, wherein the acid number is from about 10 to about 50 mg KOH/g.

3. The carpet tile of claim 1, wherein the acid number is from about 15 to about 45 mg KOH/g.

4. (canceled)

5. The carpet tile of claim 1, wherein said the functionalized polyolefin having a polyolefin backbone polymer, wherein the backbone of the functionalized polypropylene is: a) a homopolymer of propylene having an isotactic index greater than 80; b) a copolymer of propylene and an olefin selected from the group consisting of ethylene and C4-C10 alpha-olefin and the copolymer having an isotactic index greater than 85; c) a terpolymer of propylene and two olefins selected from the group consisting of ethylene and C4-C8 alpha-olefins, the terpolymer having an isotactic index greater than 85, or d) an ethylene/propylene rubber impact modified homopolymer of propylene.

6. The carpet tile of claim 5, wherein said polyolefin backbone has an isotactic index of at least 80.

7. The carpet tile of claim 6, wherein the isotactic index is from about 85 to about 99.

8. The carpet tile of claim 1, wherein said functionalized polyolefin has a melt viscosity from about 200 to about 60,000 mPas, at 190° C.

9. The carpet tile of claim 8, wherein the melt viscosity is from about 400 to about 25,000 mPas.

10. The carpet tile of claim 1, wherein said the compatibilizer is a functionalized polyolefin and it is produced by a free radical intiator.

11. The carpet tile of claim 1, wherein said the functionalized polyolefin comprises a polyolefin backbone, wherein the backbone of the functionalized polypropylene is: a) a homopolymer of propylene having an isotactic index greater than 80; b) a copolymer of propylene and an olefin selected from the group consisting of ethylene and C4-C10 alpha-olefin and the copolymer having an isotactic index greater than 85; c) a terpolymer of propylene and two olefins selected from the group consisting of ethylene and C4-C8 alpha-olefins, the terpolymer having an isotactic index greater than 85; or d) an ethylene/propylene rubber impact modified homopolymer of propylene.

12. The carpet tile of claim 11, wherein the polyolefin having isotactic >90% is functionalized with maleic anhydride.

13. The carpet tile of claim 12, wherein the maleic anhydride is present in an amount of from about 0.5 wt % to about 10 wt %, based on the weight of said isotactic polyolefin backbone.

14. The carpet tile of claim 13, wherein the maleic anhydride is present in an amount of from about 1.2 wt % to about 8 wt %, based on the weight of said isotactic polyolefin backbone.

15. The carpet tile of claim 1, wherein the at least one laminate layer further comprises:
at least one amorphous poly-alpha-olefin;
at least one filler;
at least one tackifier resin;
at least one stabilizer; and
at least one unfunctionalized polyolefin.

16. The carpet tile of claim 15, wherein
the at least one amorphous poly-alpha-olefin comprises at least one ethylene copolymer;
the at least one filler comprises coal fly ash, calcium carbonate, barium sulfate, alumina trihydrate, magnesium hydroxide, bauxite, talc, post consumer glass, post industrial glass, or any combination thereof;
the at least one tackifier resin comprises an aliphatic hydrocarbon, a cycloaliphatic hydrocarbon, an aromatically modified aliphatic hydrocarbon, fatty acid, or any combination thereof;
the at least one stabilizer comprises an antioxidant high molecular weight hindered phenol.

17. The carpet tile of claim 15, wherein the unfunctionalized polyolefin is: a) a homopolymer of propylene having an isotactic index greater than 80; b) a copolymer of propylene and an olefin selected from the group consisting of ethylene and C4 to C10 alpha-olefin and the copolymer having an isotactic index greater than 85; c) a terpolymer of propylene and two olefins selected from the group consisting of ethylene and C4 to C8 alpha-olefins, the terpolymer having an isotactic index greater than 85; or d) an ethylene/propylene rubber impact modified homopolymer of propylene.

18. The carpet tile of claim 15, wherein
the at least one amorphous poly-alpha-olefin is present in an amount of from about 5 wt % to about 30 wt %;
the functionalized polyolefin is present in an amount of from about 0.1 wt % to about 5 wt %;
the at least one filler is present in an amount of from about 40 wt % to about 80 wt %;
the at least one tackifier resin is present in an amount of from about 5 wt % to about 20 wt %;
the at least one stabilizer is present in an amount of from about 0.1 wt % to about 5 wt %; and
the at least one unfunctionalized polyolefin is present in an amount of from about 0.5 wt % to about 5 wt %,
based on the total weight of the laminate layer.

19. The carpet tile of claim 16, wherein
the at least one amorphous poly-alpha-olefin is present in an amount of about 15 wt %;
the functionalized polyolefin is present in an amount of about 1 wt %;
the at least one filler is present in an amount of about 66 wt %,
the at least one tackifier resin is present in an amount of about 10 wt %;
the at least one stabilizer is present in an amount of about 1 wt %; and
the at least one unfunctionalized polyolefin, is present in an amount of about 2 wt %,
based on the weight of the laminate layer.

20. The carpet tile of claim 1, wherein the laminate layer has a top surface and a bottom surface, and wherein the carpet tile further comprises:
a primary backing having a top surface and a bottom surface;
fibers tufted into, woven into, or bonded to, and extended upwardly from the top surface of the primary backing;
a pre-coat layer having a top surface and a bottom surface, wherein the top surface of the pre-coat is affixed to the bottom surface of the primary backing and the bottom surface of the pre-coat layer is affixed to the top surface of the laminate layer;
at least one reinforcement layer having a top surface and a bottom surface, wherein the top surface of the reinforcement layer is affixed to the bottom surface of the laminate layer; and
a hardback layer having a top surface and a bottom surface, wherein the top surface of the hardback layer is affixed to the bottom surface of the reinforcement material layer.

21. (canceled)

22. The carpet tile of claim 20, wherein the primary backing comprises polyester fibers, nylon fibers, polypropylene fibers, or any combination thereof, assembled in a woven fabric, non-woven fabric, laminated film, or any combination thereof.

23. The carpet tile of claim 20, wherein the pre-coat layer comprises a latex polymer compounded with at least one filler, at least one flame retardant, at least one smoke suppressant, at least one additive, or any combination thereof.

24. The carpet tile of claim 20, wherein the at least one reinforcement layer comprises fiberglass, wherein the fiberglass is woven, non-woven, in a wet laid mat, in a scrim, or any combination thereof.

25. The carpet tile of claim 20, wherein the pre-coat layer and/or the hardback layer comprises:
at least one amorphous poly-alpha-olefin;
at least one filler;
at least one tackifier resin;
at least one stabilizer; and
at least one unfunctionalized polyolefin.

26. The carpet tile of claim 25, wherein
the at least one amorphous poly-alpha-olefin has a melt viscosity from about 1,000 to about 9,000 mPas, at 190° C., and comprises at least one copolymer and/or homopolymer of propylene, and an olefin comprising ethylene and/or C₄-C₁₀ alpha olefin;
the at least one filler comprises coal fly ash, calcium carbonate, barium sulfate, alumina trihydrate, magnesium hydroxide, bauxite, talc, post consumer glass, post industrial glass, or any combination thereof;
the at least one tackifier resin comprises an aliphatic hydrocarbon, a cycloaliphatic hydrocarbon, an aromatically modified aliphatic hydrocarbon, fatty acid or any combination thereof;
at least one stabilizer comprises an antioxidant high molecular weight hindered phenol;
the unfunctionalized polyolefin.

27. The carpet tile of claim 20, wherein
the fibers are present in an amount of from about 10 ounces to about 40 ounces;
the pre-coat layer is present in an amount of from about 18 ounces to about 40 ounces;
the laminate layer is present in an amount of from about 25 ounces to about 35 ounces; and
the hardback layer is present in an amount of from about 30 ounces to about 40 ounces, per square yard of the carpet tile.

28. A method of making the carpet tile of claim 20, comprising applying the laminate layer to the bottom surface of the pre-coat directly or by indirect belt coating.

29. The method of claim 28, wherein the laminate layer is applied using a hot roll coater, a hot knife coater, a slot coater, a spray applicator, extruder or any combination thereof.

30. The method of claim 28, wherein the indirect belt coating comprises applying the laminate layer onto a process line belt and is independent of applying the pre-coat.

31. The method of claim 28, wherein
the hardback layer is applied onto a process line belt;
the reinforcement layer is then applied onto the hardback layer;
the laminate layer is then applied onto the reinforcement material layer to form a bottom part of said carpet tile; and
the bottom part is then attached to the bottom surface of the pre-coat layer of a pre-coated carpet tile to form a finished carpet tile.

32. The method of 28, wherein
the laminate layer is applied on the bottom surface of the pre-coat layer of a pre-coated carpet tile;
the reinforcement layer is then applied onto the laminate layer; and
the hardback layer is then applied onto the reinforcement material layer.
